(19) United States
(12) Patent Application Publication
(10) Pub. No.: US 2007/0209246 A1
(43) Pub. Date: Sep. 13, 2007

(54) Advertisement system

(75) Inventor: Eric Alexus Neckel, Bellvue, CO (US)

Correspondence Address: CR MILES, P.C.;CRAIG R. MILES, 405 MASON COURT, SUITE 119, FORT COLLINS, CO, 80524, US

(73) Assignee: Advertising Systems, LLC

(21) Appl. No.: 11/350,295

(22) Filed: Feb. 7, 2006

(51) Int. Cl. B65H 75/14; G09F 3/00

(52) U.S. Cl. 40/309; 242/600

(57) ABSTRACT

An advertisement applied to the surface of a core element concealed by an amount of material wound about the surface of the core element such advertisement revealed as the amount of material unwinds from the surface of the core element.

### I. BACKGROUND

An advertisement applied to the surface of a core element concealed by an amount of material wound about the surface of the core element such advertisement revealed as the amount of material unwinds from the surface of the core element.

There is a large commercial market for materials wound on tubes or spools such as paper towels, toilet paper, or the like. Typically, an amount of material is wound on the tube or spool and dispensed in portions until the amount of material wound about the tube or spool is consumed in the entirety and the remaining tube or spool is discarded. The discarded tube or spool is typically replaced by the consumer with another roll of material.

It appears to have been entirely overlooked that the surface of the tube, spool, or other core element about which such material (s) can be wound has a substantial surface area which presents itself to the consumer as the material is consumed and which may be a surface on which an advertisement can be applied.

### II. SUMMARY OF THE INVENTION

Accordingly, a broad object of the invention can be to provide an advertisement applied to the surface of a tube, spool, or core element concealed by an amount of material wound about the surface of the core element such advertisement revealed as the amount of material unwinds from the surface of the core element.

A second broad object of the invention can be a method of making an advertisement by applying the advertisement to the surface of a tube, spool, or core element and concealing the advertisement by winding an amount of material wound about the core element.

A third broad object of the invention can be a method of advertising by which the consumer unwinds the amount of material wound about the tube, spool or core element to expose the surface of the core element and revealing the advertisement.

Naturally, further objects of the invention are disclosed throughout other areas of the specification, drawings, photographs, and claims.

### III. A BRIEF DESCRIPTION OF THE DRAWINGS

FIG. 1 is a perspective view of an embodiment of the invention which provides an amount of material capable of being unwound from a core element.

FIG. 2 is a perspective view of the embodiment of the invention shown by FIG. 1 which reveals an advertisement upon unwinding the amount of material from the core element.

FIG. 3 is a perspective view of another embodiment of the invention which provides an amount of material capable of being unwound from a core element.

FIG. 4 is a perspective view of the embodiment of the invention shown by FIG. 3 which reveals an advertisement upon unwinding the amount of material from the core element.

### IV. DETAILED DESCRIPTION OF THE PREFERRED EMBODIMENTS

An advertisement applied to the surface of a core element concealed by an amount of material wound about the surface of the core element and revealed as the amount of material is unwound from the surface of the core element.

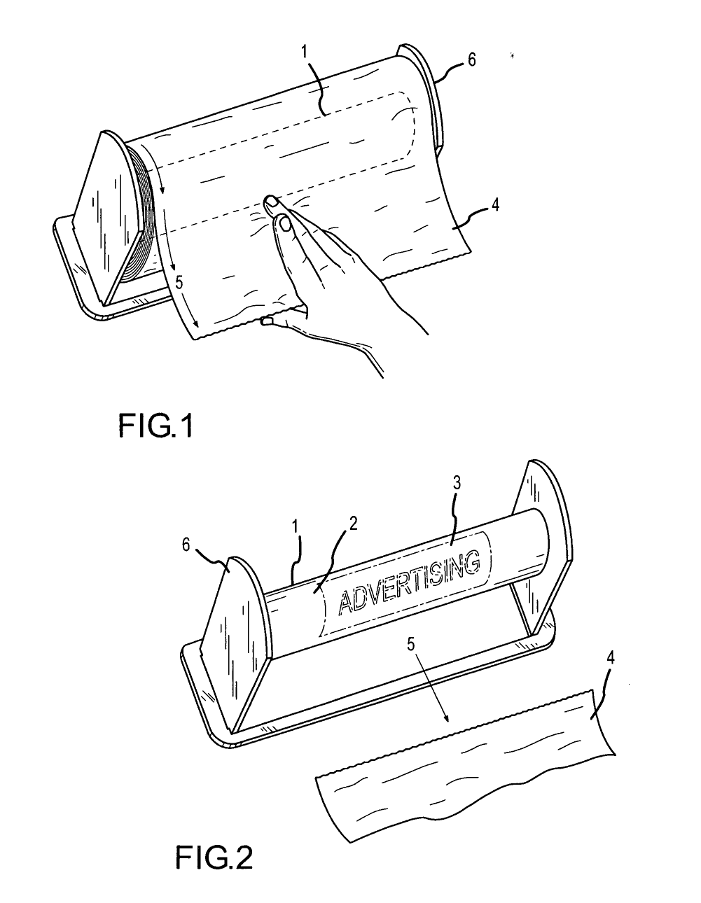

First referring primarily to FIGS. 1-2, a core element (1) (shown by broken lines in Figure (1) can provide a surface (2) on which an advertisement (3) can be applied. The term core element as use herein refers to any constructional form configured to provide a surface on which an amount of material can be wound. The core element may include surface impressions, relief, or other visual elements generated as a result of or during the core element manufacturing process. For example, a cardboard tube can be manufactured by engaging a pair of opposed edges of a planar sheet of cardboard to generate a substantially cylindrical configuration. Integral to a cardboard tube generated by this process may be a spiral impression or relief on the surface of the cardboard at the location at which the pair of opposed edges join. Similarly, there may be marks on the surface of the core element due to inadvertent impact(s) or may be intended marks such as serial numbers, bar code labels, tracking numbers, the core element business identification, or the like. For example, the core element can be a conventional paper, cardboard, or plastic tube on which conventional paper towels or toilet paper can be wound; however, the invention is not so limited.

The term advertisement as used herein refers to visually perceivable markings applied to the external surface of the core element intended to be revealed to the public to promote a business, service or product. The advertisement can be applied to the surface in any manner such as labels, print, impression, relief, cutout, or the like. For example, the advertisement can be retail product information imprinted on the external surface of the core element intended to induce the viewer to purchase the retail product, or the like. However, the term advertisement specifically excludes the constructional form or surface configuration of the core element as above-described. For example, advertisement does not include impressions, relief, or marks generated on the surface of the core element due to the joining of surfaces, inadvertent impact or marking, or intended imprinted serial or tracking numbers, identifiers of the manufacturer of the core element, or the like.

Again referring to FIGS. 1 and 2, an amount of material (4) can be wound about the core element (1) to conceal the advertisement (3) applied to the external surface (2) of the core element (1). The amount of material (4) can be any of a wide variety of materials such as paper towel material(s), aluminum foil, brown paper, wrapping paper, toilet paper(s), cord, wire, or the like, which when wound about the surface (2) of the core element (1) conceal the advertisement from being viewed and which are capable of being unwound (5) from about the surface (2) of the core element (1). Specifically, excluded from the term “an amount of material” are materials which are incapable of being wound about the core element (1) to conceal the advertisement (3). However, the invention encompasses material(s) which as a single layer may allow visualization of the advertisement (3) to a greater or lesser degree but which upon winding one or more additional layers about the surface of the core element (1) can conceal the advertisement (3).

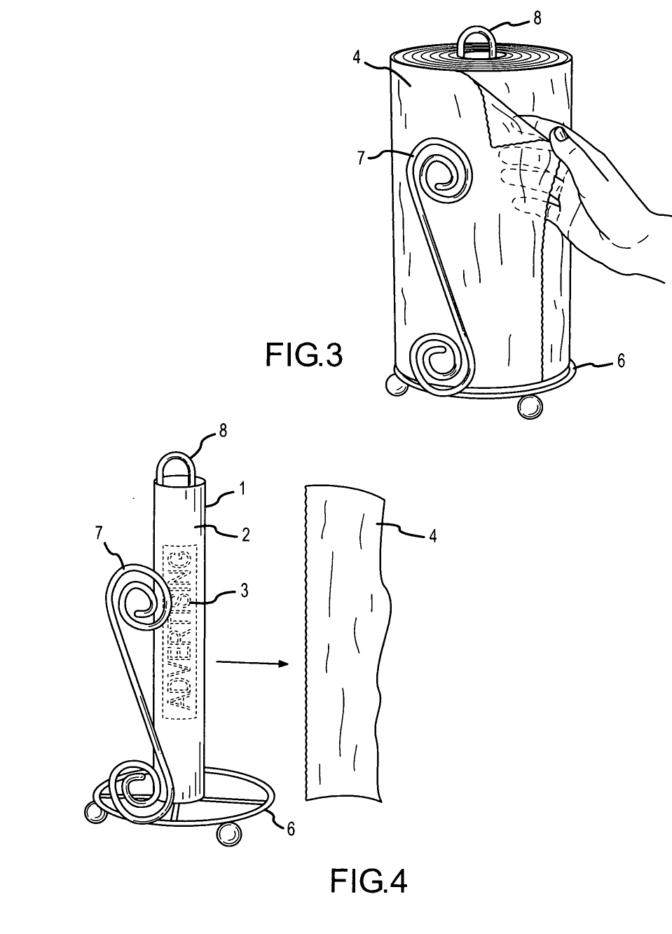

Now referring to FIGS. 1-4, the invention can further include a material dispenser (6) which engages the core element (1) as shown by FIGS. 1 and 2, or the amount of material (4) wound about the core element (1) as shown by FIGS. 3 and 4 in which a material engagement member (7) engages the amount of material (4), or both, as shown by FIGS. 3 and 4 which further includes a core element insertion member (8). While specific examples of a material dispenser (6) are shown, the invention is not so limited and any constructional form of material dispenser (6) can be utilized which allows the amount of material (4) to be unwound from about the core element (1). It is not intended that the invention be limited by the direction in which the core element (1) is disposed and the core element (1) can be disposed in any direction whether horizontal as shown by FIGS. 1 and 2 or vertical as shown by FIGS. 3 and 4 or in any direction which allows the amount of material to be unwound (5) from about the core element (1).

A method of making the invention can include the steps of obtaining a core element (1) having a surface about which an amount of material (4) can be wound. Obtaining the core element (1) means having sufficient control over the core element (1) to perform the further step of applying at least one advertisement to the surface (2) of the core element (1). As the term obtaining a core element (1) can encompass a step of a production process whether automated or manual which allocates a sufficient duration of time in which the step of applying at least one advertisement to said surface of said core element can be achieved. Applying at least one advertisement to said surface of said core element encompasses utilizing those processes which can generate the visually perceivable markings applied to the external surface of the core element intended to be revealed to the public to promote a business, service or product as above described. Winding an amount of a material (4) about the surface (2) of the core element (1) to conceal the advertisement (3) can be achieved by any material winding means whether automated or manual so long as the material winding means generates an amount of material (4) capable of unwinding from about the surface (2) of the core element (1) to reveal the advertisement (3).

Again referring to FIGS. 1-4, a method of using the invention can include the step of obtaining an amount of material (4) wound about a surface (2) of a core element (1) as shown by the non-limiting examples shown in FIGS. 1 and 3. The step of obtaining the amount of material wound about the surface of the core element means having sufficient control over the core element (1) wound with the amount of material to allow unwinding of a portion of the amount of material from about the surface of the core element (1). By unwinding (5) the amount of material (4) from about the surface (2) of said core element (3) (as shown by the non-limiting examples of FIGS. 1 and 3) the amount of material can be removed from the surface (2) of the core element (1) exposing the surface (2) of the core element (1)(as shown by the non-limiting examples of FIGS. 2 and 4) about which the amount of material (4) is wound thereby revealing at least one advertisement (3) applied to said surface (2) of said core element (1)(as shown by the non-limiting examples of FIGS. 2 and 4).

The step of exposing the surface (2) of the core element (1) is not intended to be limited to those embodiments of the invention as shown by FIGS. 2 and 4 in which the amount of material (4) entirely disengages from the surface (2) of the core element (1) but further includes those embodiments of the invention in which a portion of the amount of material may remain engaged to the surface (2) of the core element (1) so long as the amount of material which remains engaged does not preclude the step of revealing at least one advertisement applied to said surface of said core element. As a non-limiting example, a portion of the amount of material (4) may be engaged by an adhesive to the surface (2) of the core element (1). Upon completion of the step of exposing said surface (2) of the core element (1) about which said amount of material (4) is wound the adhesive may retain a portion of the amount of material (4) to the surface (2) of the core element (1). The amount of material (4) retained by the adhesive may be a continuous or discontinuous layer of the amount of material (4) engaged to a greater or lesser portion of the surface of the core element apart from or at the location of the advertisement; however, if the surface of the core element has been exposed sufficient to reveal at least one advertisement applied to the surface of the core material the step has been achieved.

As can be easily understood from the foregoing, the basic concepts of the present invention may be embodied in a variety of ways. The invention involves numerous and varied embodiments of an advertisement system and methods of making and using such advertisement system.

As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of an “advertisement” should be understood to encompass disclosure of the act of “advertising”—whether explicitly discussed or not—and, conversely, were there effectively disclosure of the act of “advertising”, such a disclosure should be understood to encompass disclosure of an “advertisement” and even a “means for advertising.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Thus, the applicant(s) should be understood to claim at least: i) each of the advertisement systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth below are intended describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A method of advertising, comprising the steps of:
a. obtaining a core element having a surface;
b. applying at least one advertisement to said surface of said core element; and
c. winding an amount of a material about said surface of said core element to conceal said advertisement, said amount of material capable of unwinding from about said surface of said core element to reveal said advertisement.

2. A method of advertising, comprising the steps of:
a. obtaining an amount of material wound about a surface of a core element;
b. unwinding said amount of material from about said surface of said core element;
c. exposing said surface of said core element about which said amount of material is wound; and
d. revealing at least one advertisement applied to said surface of said core element.

3. An advertisement, comprising:
a. a core element;
b. an advertisement applied to a surface of said core element; and
c. an amount of material wound about said core element to conceal said advertisement applied to said surface of said core element, said amount of material capable of being unwound from about said surface of said core element to reveal said advertisement.
